(19) United States
(12) Patent Application Publication
(10) Pub. No.: US 2006/0265252 A1
(43) Pub. Date: Nov. 23, 2006

(54) Information processing apparatus and information processing method

(75) Inventors: Yuichi Nishii, Kawasaki-shi (JP); Tsukasa Sako, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/434,151

(22) Filed: May 16, 2006

(30) Foreign Application Priority Data
May 20, 2005 (JP) 2005-148564
Feb. 24, 2006 (JP) 2006-048975

(51) Int. Cl. G06F 19/00; G06F 17/30

(52) U.S. Cl. 705/3; 707/1

(57) ABSTRACT

Processing of searching for personal information and image processing parameters specified by image identification information (S31) and specifying readable elements of the readout personal information to be transmitted to a user terminal is executed (S32). Of the elements contained in the personal information searched in step S31, the elements specified in step S32 are read out (S33). Medical image data specified by image identification information is searched for and subjected to image processing using the image processing parameters found in step S31 (S34). The elements read out in step S33 are added to the medical image data which has undergone image processing (S35), and the medical image is transmitted to the user terminal (S36).

### FIELD OF THE INVENTION

The present invention relates to a medical image management technique.

### BACKGROUND OF THE INVENTION

Conventionally, a photo is taken by an X-ray apparatus, the film is developed, and diagnostic reading is done by using a viewbox. However, since digital X-ray apparatuses have been developed, an X-ray image is captured by a computer as digital data. Hence, diagnostic reading is executed nowadays by displaying an X-ray image on the display of a computer.

At this time, pieces of supplementary information such as the name, date of birth, sex, and age of the patient, the name of a disease, and the acquisition datetime are displayed on the display together with the X-ray image. A technique of, e.g., turning off display of the personal information depending on the accessing operator has already been disclosed (Japanese Patent Laid-Open No. 2003-216496).

Generally, patient's personal information must be protected. However, patient's personal information is indispensable in, e.g., medical examination and treatment of each individual patient and cannot entirely be hidden.

It is therefore necessary to limit personal information in accordance with the utilization purpose. The personal information includes not only the name and date of birth of a patient but also a very rare case that helps specify a patient.

### SUMMARY OF THE INVENTION

The present invention has been made in consideration of the above-described problem, and has as its object to provide a technique of making it possible to refer to only some of elements contained in patient's personal information in accordance with conditions.

In order to achieve an object of the present invention, for example, an information processing apparatus of the present invention comprises the following arrangement.

That is, an information processing apparatus capable of accessing a database in which a plurality of sets of a patient's medical image and personal information about the patient are registered, comprising:

holding means for holding a read condition for elements contained in the personal information;

specifying means for, upon detecting that access information to access a patient's medical image in the database is input from an outside, specifying a readable element of the elements contained in the personal information registered in the database in association with the medical image;

read means for reading out the element specified by the specifying means and the medical image from the database; and

output means for outputting the element read out by the read means and the medical image to the outside.

In order to achieve an object of the present invention, for example, an information processing method of the present invention comprises the following arrangement.

That is, an information processing method executed by an information processing apparatus capable of accessing a database in which a plurality of sets of a patient's medical image and personal information about the patient are registered, comprising:

a holding step of holding, in a memory, a read condition for elements contained in the personal information;

a specifying step of, upon detecting that access information to access a patient's medical image in the database is input from an outside, specifying a readable element of the elements contained in the personal information registered in the database in association with the medical image;

a read, step of reading out the element specified in the specifying step and the medical image from the database; and

an output step of outputting the element read out in the read step and the medical image to the outside.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of a system capable of acquiring and managing a patient's medical image together with his/her personal information and providing the information under management as needed;

FIG. 2 is a flowchart of processing of registering, in an external storage device 606, medical image data and information about it which are sent from an image sensing apparatus 100;

FIG. 3 is a flowchart of processing executed by a server apparatus 12 upon receiving, from a user terminal 106, a transmission request of a desired medical image and information about it;

FIG. 4 is a flowchart of processing of causing the user terminal 106 to determine readable elements of personal information as a browsing request target;

FIG. 5 is a view showing a structure example of a table held in a rule storage unit 113 in the external storage device 606;

FIG. 6 is a block diagram showing the hardware configuration of a computer applicable to the server apparatus 12;

FIG. 7 is a view showing an example of a database 105; and

FIG. 8 is a view showing an example of a special case database 120.

### DETAILED DESCRIPTION OF THE PREFERRED EMBODIMENTS

Preferred embodiments of the present invention will now be described in detail in accordance with the accompanying drawings.

### First Embodiment

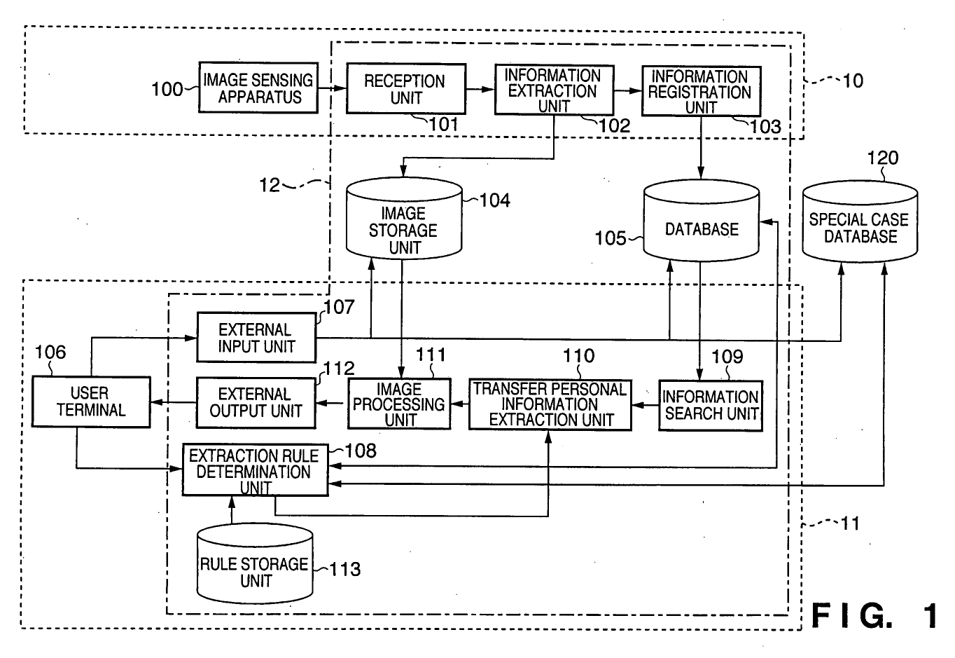

FIG. 1 is a block diagram showing the functional arrangement of a system capable of acquiring and managing a patient's medical image together with his/her personal information and providing the information under management as needed.

The system according to this embodiment comprises an image sensing apparatus 100, server apparatus 12, and user terminal 106, as shown in FIG. 1.

The image sensing apparatus 100 will be described. The image sensing apparatus 100 senses a patient's medical image and transmits, to the server apparatus 12, information (e.g., the name, date of birth, sex, and age of the patient, the name of a disease, and the acquisition datetime) about the sensed medical image together with the data of the medical image. The information about the medical image contains patient's personal information (e.g., the name, date of birth, sex, and age of the patient, and the name of a disease) and image processing parameters.

The user terminal 106 will be described next. The user terminal 106 is used to access the server apparatus 12 to acquire a desired medical image and information about it.

The server apparatus 12 will be described next. The server apparatus 12 includes a reception unit 101, information extraction unit 102, information registration unit 103, image storage unit 104, database 105, external input unit 107, external output unit 112, extraction rule determination unit 108, rule storage unit 113, image processing unit 111, transfer personal information extraction unit 110, and information search unit 109.

The reception unit 101 receives medical image data and information about the medical image, which are transmitted from the image sensing apparatus 100, and outputs them to the information extraction unit 102 of the succeeding stage.

Upon receiving the medical image data from the reception unit 101, the information extraction unit 102 outputs the data to the image storage unit 104. Upon receiving the information about the medical image from the reception unit 101, the information extraction unit 102 extracts personal information and image processing parameters from the information about the medical image and outputs them to the information registration unit 103 of the succeeding stage.

The information registration unit 103 outputs, to the database 105, the personal information and image processing parameters received from the information extraction unit 102. The personal information and image processing parameters are registered in the database 105 in association with the medical image registered in the image storage unit 104.

Reference numeral 10 in FIG. 1 denotes a part to register the medical image and information about it in the image storage unit 104 and database 105, respectively.

Information to identify an access target medical image, i.e., information to identify a desired medical image to be browsed on the side of the user terminal 106 is input from the user terminal 106 to the external input unit 107. On the basis of the information, the external input unit 107 searches for a medical image indicated by the received information from a plurality of medical images stored in the image storage unit 104 and outputs the found image to the image processing unit 111.

On the basis of the information to identify the access target medical image, i.e., the information to identify the desired medical image to be browsed on the side of the user terminal 106 (e.g., only for a “doctor”), the external input unit 107 can also add, change, and delete personal information such as the name of a disease and symptoms after diagnosis or add, change, and delete personal information in case of an error in the patient's name or an omission. The personal information is reflected on the database 105 through the external input unit 107.

Information indicating the access purpose of the user terminal 106 to the server apparatus 12 and information to identify the operator of the user terminal 106 are input from the user terminal 106 to the extraction rule determination unit 108. Using the pieces of received information and a table (to be described later) stored in the rule storage unit 113, the extraction rule determination unit 108 executes processing of specifying readable elements of personal information that is associated with the medical image as the access target of the user terminal 106.

The information search unit 109 reads out, of the personal information and image processing parameters registered in the database 105, personal information and image processing parameters corresponding to the medical image read out from the image storage unit 104 by the external input unit 107, and outputs the readout information and parameters to the transfer personal information extraction unit 110 of the succeeding stage.

The transfer personal information extraction unit 110 extracts only elements specified by the extraction rule determination unit 108 from the elements of the personal information received from the information search unit 109 and outputs the extracted elements to the image processing unit 111 together with the image processing parameters received from the information search unit 109. The image processing unit 111 processes the medical image searched by the external input unit 107 by using the image processing parameters received from the transfer personal information extraction unit 110 and outputs the processed medical image to the external output unit 112 together with the elements received from the transfer personal information extraction unit 110. The external output unit 112 transmits the processed medical image and elements received from the image processing unit 111 to the user terminal 106.

Reference numeral 11 in FIG. 1 denotes data commutation between the server apparatus 12 and the user terminal 106.

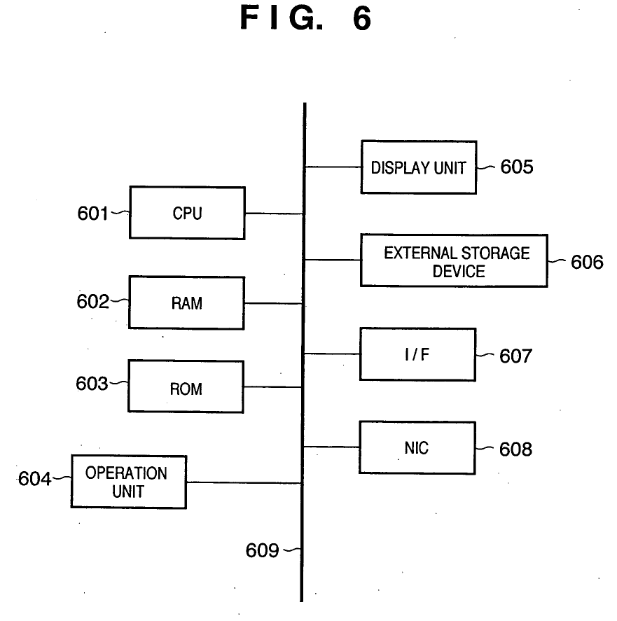

FIG. 6 is a block diagram showing the hardware configuration of a computer applicable to the server apparatus 12. In this embodiment, a computer having the configuration shown in FIG. 6 is applied to the server apparatus 12. However, the configuration applicable to the server apparatus 12 is not limited to that shown in FIG. 6.

A CPU 601 controls the entire server apparatus 12 by using programs and data stored in a RAM 602 or ROM 603 and also executes processing (to be described later) of the server apparatus 12. The units of the server apparatus 12 shown in FIG. 1, except the image storage unit 104, database 105, and rule storage unit 113, operate as several functions of the CPU 601.

The RAM 602 can provide, as needed, various kinds of areas such as an area to temporarily store programs and data loaded from an external storage device 606, an area to temporarily store data received from an external device through an I/F 607 and NIC 608, and a work area to be used by the CPU 601 to execute various kinds of processing.

The ROM 603 stores boot programs and setting data of the server apparatus 12.

An operation unit 604 including a keyboard and mouse is operated by the operator of the server apparatus 12 to input various kinds of instructions to the CPU 601.

A display unit 605 including a CRT or liquid crystal display screen can display a processing result of the CPU 601 as an image or characters.

The external storage device 606 is a mass storage device represented by a hard disk drive device. An OS (Operation System) and programs and data to make the CPU 601 execute various kinds of processing of the server apparatus 12 are saved in the external storage device 606. The programs and data are loaded in the RAM 602 under the control of the CPU 601 as needed. The image storage unit 104, database 105, and rule storage unit 113 shown in FIG. 1 are provided in the external storage device 606. Some or all of the areas which are explained above to be provided in the RAM 602 may be provided in the external storage device 606.

The I/F 607 is connected to the image sensing apparatus 100 so that medical image data and information about it, which are output from the image sensing apparatus 100, are input to the RAM 602 or external storage device 606 through the I/F 607.

The NIC 608 (network interface) connects the server apparatus 12 to a network such as a LAN or Internet. The user terminal 106 is also connected to the network. Hence, the server apparatus 12 can perform data communication with the user terminal 106 connected to the network through the NIC 608.

A bus 609 connects the above-described units to each other.

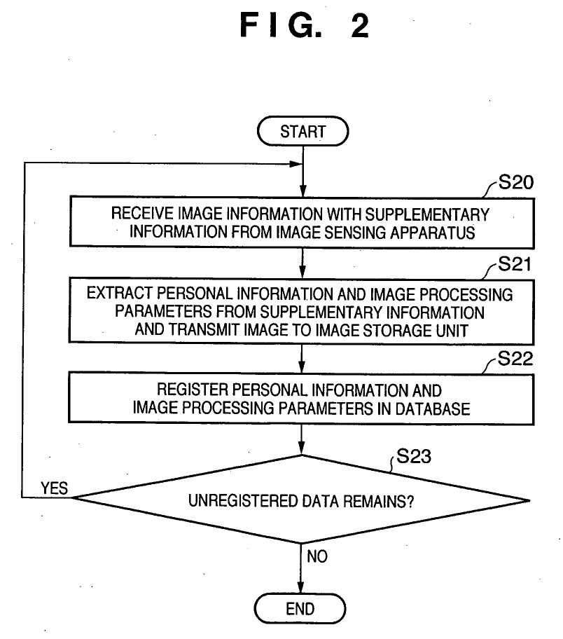

Processing of registering, in the external storage device 606, medical image data and information about it which are sent from the image sensing apparatus 100 will be described below with reference to FIG. 2 showing the flowchart of the processing. Programs and data to be used by the CPU 601 to execute the processing corresponding to the flowchart in FIG. 2 are saved in the external storage device 606 and loaded in the RAM 602 under the control of the CPU 601. When the CPU 601 executes the processing by using the programs and data, the server apparatus 12 executes each processing to be described below.

First, the image sensing apparatus 100 inputs medical image data and information (supplementary information) about it to the server apparatus 12 through the I/F 607. The CPU 601 functions as the reception unit 101 to store the information in the RAM 602 or external storage device 606 (step S20).

Next, the CPU 601 functions as the information extraction unit 102 to register the medical image data received from the image sensing apparatus 100 in the image storage unit 104 provided in the external storage device 606 (step S21). In registering the medical image data, information such as a file name to identify it is added by the CPU 601.

The CPU 601 also functions as the information registration unit 103 to extract personal information and image processing parameters from the information about the medical image received from the image sensing apparatus 100 and register the information and parameters in the database 105 provided in the external storage device 606 (step S22). The personal information and image processing parameters are registered together with the information to identify the medical image data registered in step S21. That is, the medical image data registered in step S21 and the personal information and image processing parameters registered in step S22 are associated with each other. In this embodiment, the registration destination of the medical image data is different from that of the personal information and image processing parameters. However, they may be registered in the same database in association with each other.

Referring back to FIG. 2, if unregistered data remains in the image sensing apparatus 100, the processing returns to step S20. If no unregistered data remains in the image sensing apparatus 100, the processing is ended.

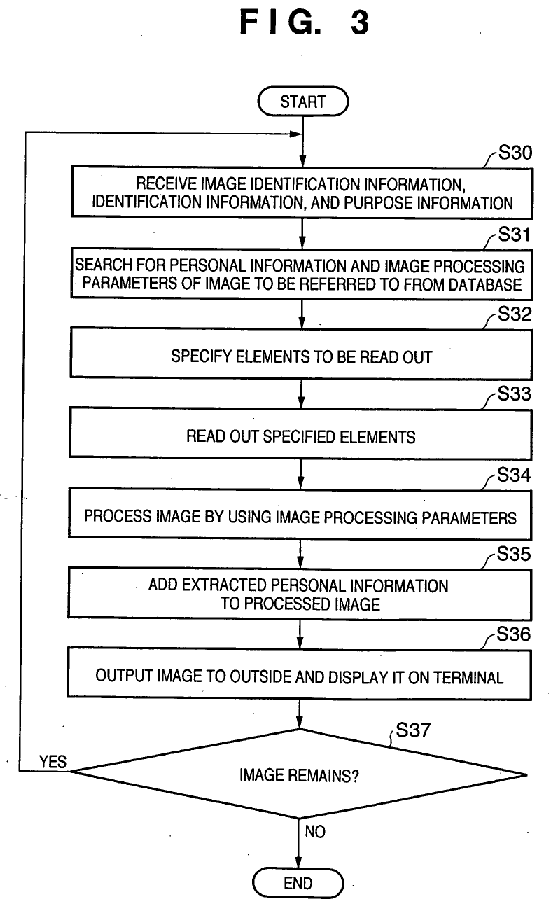

Processing executed by the server apparatus 12 upon receiving, from the user terminal 106, a transmission request of a desired medical image and information about it will be described next with reference to FIG. 3 showing the flowchart of the processing.

To browse medical image data registered in the external storage device 606, the operator of the user terminal 106 must transmit, to the server apparatus 12, information (image identification information), e.g., a file name to identify the medical image data to be browsed.

In addition, to browse (use) medical image data, information (purpose) indicating the utilization purpose, e.g., information representing that the medical image data is necessary for medical examination of the patient or one appropriate medical image data is necessary as a material for presentation in an academic society must be transmitted to the server apparatus 12.

Furthermore, information (identification information) to identify the operator who is operating the user terminal 106 must be transmitted to the server apparatus 12.

On the side of the user terminal 106, these pieces of information are set by, e.g., GUI. The pieces of set information are transmitted to the server apparatus 12.

When the user terminal 106 transmits the information group, i.e., image identification information, identification information, and purpose information to the server apparatus 12, they are input to the server apparatus 12 through the NIC 608. Upon detecting input of the information, the CPU 601 of the server apparatus 12 stores these pieces of information in the RAM 602 or external storage device 606 (step S30).

Personal information and image processing parameters specified by the image identification information are searched from the personal information and image processing parameters stored in the database 105 in the external storage device 606 (step S31). More specifically, a set of personal information and image processing parameters are registered in the database 105 in correspondence with each medical image, as described above. Each set is made to correspond to a medical image by image identification information. Hence, when image identification information is designated, medical image data, personal information, and image processing parameters can be searched uniquely.

Readable elements of the personal information read out in step S31, which are to be transmitted to the user terminal 106, are specified (step S32). Details of the processing in this step will be described below.

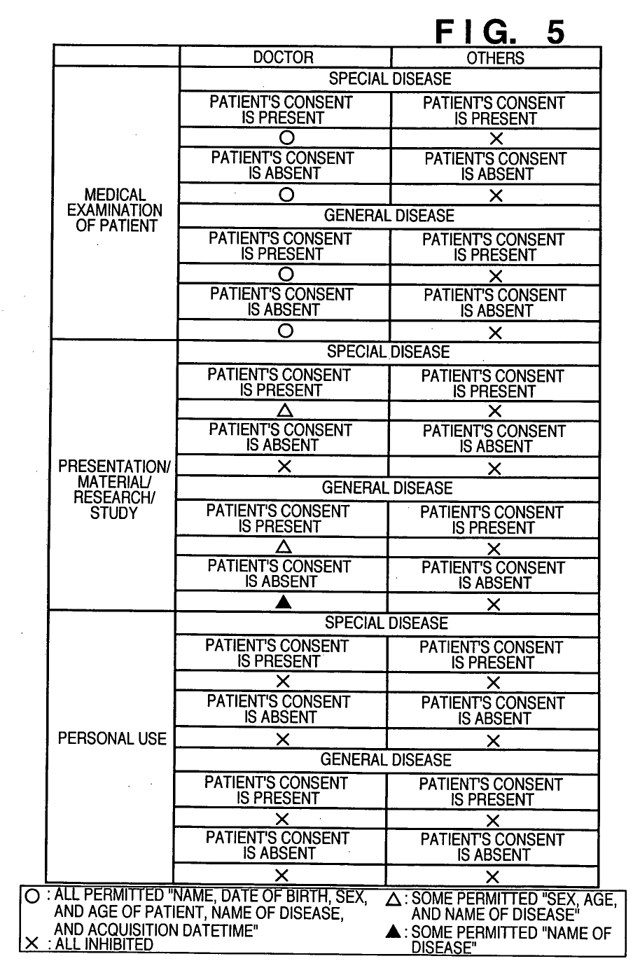

FIG. 5 is a view showing a structure example of a table held in the rule storage unit 113 in the external storage device 606. The table shown in FIG. 5 shows elements of personal information which are readable in correspondence with identification information, purpose information, the type of patient's disease, and the presence/absence of patient's consent. In other words, the table shows read conditions of each element of personal information.

In this embodiment, a “special disease” indicates a disease generally called a special case or intractable disease. It also indicates the name of a disease with few cases in the hospital equipped with this system, e.g., the name of a disease with only few cases in the database or whose ratio is only several percent.

For example, assume that the identification information is “doctor”, the purpose information is “presentation/material/research/study”, the type of patient's disease is “general disease”, and patient's consent is “absent”. In this case, only “name of disease” is the readable element of the personal information searched in step S31.

Assume that the identification information is “doctor”, the purpose information is “medical examination of the patient himself/herself”, and the type of patient's disease is “general disease”. In this case, all elements contained in the personal information searched in step S31 are readable.

When the identification information is “doctor”, the purpose information is “presentation/material/research/study”, and the type of patient's disease is “special disease”, the patient may be specified. Hence, if patient's consent is “absent”, none of the elements contained in the personal information searched in step S31 are readable. If patient's consent is “present”, “sex, age, and name of disease” are the readable elements of the personal information searched in step S31.

As described above, the readable elements can be specified in accordance with various conditions by referring to the table in FIG. 5. In this embodiment, the pieces of information representing “type of disease” and “presence/absence of patient's consent” are not input to the server apparatus 12. These pieces of information can be set on the side of the user terminal 106 and transmitted to the server apparatus 12 as needed. Conditions to specify readable elements are not limited to those shown in the table in FIG. 5 and can be changed as needed.

That is, the readable elements change depending on various conditions. Since various “conditions” are available, the information to be used to specify the readable elements is not particularly limited.

Referring back to FIG. 3, of the elements contained in the personal information searched in step S31, the elements specified in step S32 are read out (step S33).

Next, of the medical image group registered in the image storage unit 104 in the external storage device 606, medical image data specified by the image identification information received in step S30 is searched. The found medical image is subjected to image processing using the image processing parameters found in step S31 (step S34). The image processing including gray level processing and sharpening optimizes the gray level properties.

The elements (partial personal information) read out (extracted) in step S33 are added to the medical image data that has undergone image processing (step S35). The medical image data is transmitted to the user terminal 106 (step S36).

It is determined whether a medical image to be transmitted to the user terminal 106 remains (step S37). If YES in step S37, the processing returns to step S30. Otherwise, the processing is ended.

As described above, according to this embodiment, since necessary medical information can be used without violating patient's privacy, personal information can smoothly selectively be used case by case. Hence, extra processing of turning on/off display of personal information can be omitted, resulting in high usability for a doctor.

### Second Embodiment

In the first embodiment, processing of determining elements transmittable to the user terminal 106 is executed on the side of the server apparatus 12. In the second embodiment, the elements are determined on the side of a user terminal 106.

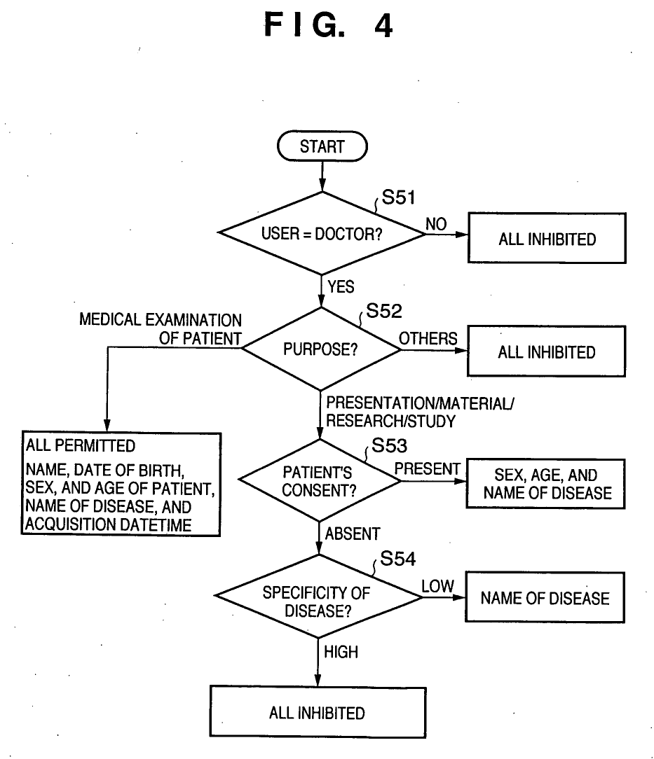

FIG. 4 is a flowchart of processing of causing the user terminal 106 to determine readable elements of personal information as a browsing request target. Elements contained in personal information are the “name, date of birth, sex, and age of a patient, name of a disease, and acquisition datetime”, for the descriptive convenience.

To acquire a patient's medical image and information about it from a server apparatus 12 by using the user terminal 106, the operator of the user terminal 106 sets the identification information of his/her own, the purpose of medical image acquisition, the presence/absence of patient's consent, the type (degree of specificity) of patient's disease, and the like by using GUI. Processing corresponding to the flowchart in FIG. 4 is executed after the setting processing.

It is checked on the basis of the identification information set by using GUI whether the operator is a doctor (step S51). If it is determined by check that the identification information does not indicate a doctor, all elements contained in the patient's personal information to be browsed are determined as unreadable.

If the identification information indicates a doctor, the processing advances to step S52 to check on the basis of the purpose information set by using GUI whether the purpose of browsing of the personal information is the medical examination of the patient having the personal information, presentation/material/research/study, or others (step S52). If it is determined by check that the purpose is medical examination of the patient himself/herself, all elements contained in the patient's personal information are determined as readable. If the purpose is others, all elements contained in the patient's personal information to be browsed are determined as unreadable.

If the purpose is presentation/material/research/study, the processing advances to step S53 to check whether the patient's consent is present (step S53). If it is determined by check that the patient's consent is present, “sex, age, and name of disease” of the elements contained in the personal information are determined as readable.

If there is no patient's consent, the processing advances to step S54 to check the specificity of the patient's disease (step S54). If it is determined by check that the specificity is less than a threshold value, i.e., the disease is a general disease, only “name of disease” of the elements contained in the personal information is determined as readable.

If the specificity is more than the threshold value, or the disease is registered in a special case database 120, all elements contained in the personal information are determined as unreadable.

The patient's medical image and, of the elements contained in the patient's personal information, the elements determined as readable by the above-described processing are requested of the server apparatus 12.

### Third Embodiment

In the above-described embodiments, only one user terminal can execute data communication with the server apparatus 12. However, a plurality of user terminals may communicate with the server apparatus. More specifically, a plurality of user terminals may be connected to the network to which a server apparatus 12 is connected such that each user terminal can request a medical image and information about it of the server apparatus 12.

In this case, the server apparatus 12 executes the processing described in the first embodiment with respect to each user terminal. Each user terminal may execute the operation described in the second embodiment, as a matter of course.

### Fourth Embodiment

The user terminal may be operated by a patient. That is, a patient may browse his/her medical images or personal information on the user terminal. In this case, the patient inputs identification information (e.g., the patient's number printed on the consultation ticket) issued for him/her in advance to the user terminal. The user terminal transmits, to a server apparatus 12, a transmission request of the latest medical image of the patient (the date and time of the medical image to be used may be designated by the patient himself/herself) and all elements contained in the patient's personal information. The server apparatus 12 transmits the requested medical image and the patient's personal information to the user terminal. Hence, the patient can browse the requested medical image and his/her personal information.

### Other Embodiment

The object of the present invention can also be achieved by supplying a recording medium (or storage medium) which records software program codes for implementing the functions of the above-described embodiments to a system or apparatus and causing the computer (or CPU or MPU) of the system or apparatus to read out and execute the program codes stored in the recording medium. In this case, the program codes read out from the recording medium implement the functions of the above-described embodiments by themselves, and the recording medium which records the program codes constitutes the present invention.

The functions of the above-described embodiments are implemented not only when the readout program codes are executed by the computer but also when the operating system (OS) running on the computer performs part or all of actual processing on the basis of the instructions of the program codes.

The functions of the above-described embodiments are also implemented when the program codes read out from the storage medium are written in the memory of a function expansion card inserted into the computer or a function expansion unit connected to the computer, and the CPU of the function expansion card or function expansion unit performs part or all of actual processing on the basis of the instructions of the program codes.

When the present invention is applied to the recording medium, the recording medium stores program codes corresponding to the above-described flowcharts.

The data format in saving or data communication in the above-described embodiments will be described.

Medical image data and information about it, which are sent from the image sensing apparatus 100, are transmitted in accordance with a standard called DICOM (Digital and Communication in Medicine) (the standard of digital images and communications in medicine).

The information about the medical image is extracted from the data by the information extraction unit 102 and saved in the database 105 together with the path to a RAW data format image. The image in the RAW data format (only image data without header) is saved in the image storage unit.

In invoking an image, the user terminal 106 accesses the RAW data format image on the path described in the database 105 by referring to it. Information about the medical image such as personal information extracted in accordance with the RAW data format image and extraction rule is transmitted to the user terminal in accordance with the DICOM standard.

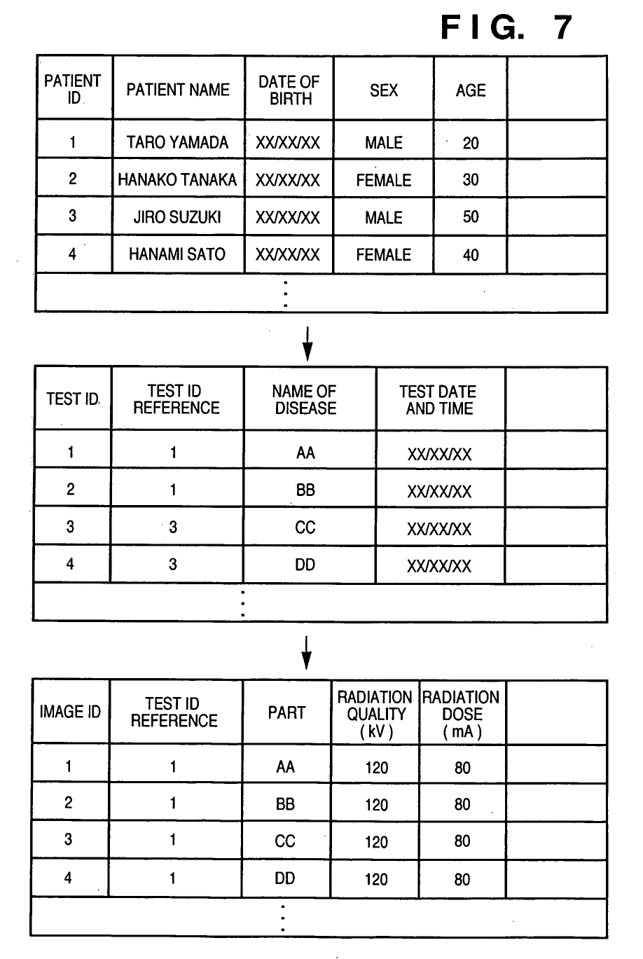

Specificity determination in step S54 is done by the extraction rule determination unit. The names of diseases in the database as shown in FIG. 7 are counted, and diseases whose number is less than a predetermined threshold value are extracted as diseases with high specificity.

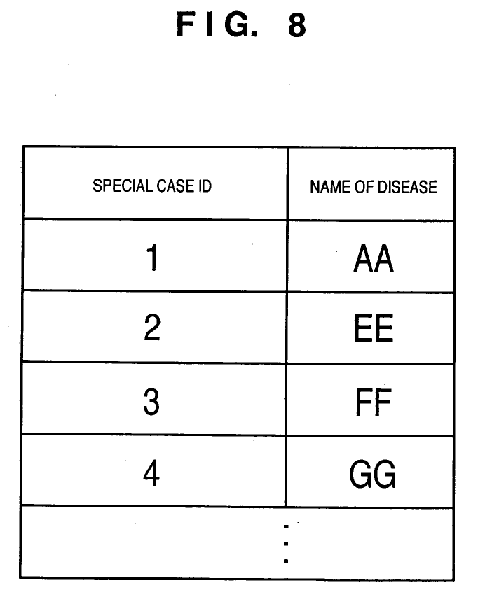

Alternatively, the names of diseases in a special case database shown in FIG. 8 are compared with those in the database shown in FIG. 7. Diseases registered in the special case database 120 are determined to have high specificity.

As many apparently widely different embodiments of the present invention can be made without departing from the spirit and scope thereof, it is to be understood that the invention is not limited to the specific embodiments thereof except as defined in the appended claims.

This application claims the benefit of Japanese Application Nos. 2005-148564 filed May 20, 2005, and 2006-048975 filed Feb. 24, 2006, which are hereby incorporated by reference herein in their entirety.

What is claimed is:

1. An information processing apparatus capable of accessing a database in which a plurality of sets of a patient's medical image and personal information about the patient are registered, comprising:
holding means for holding a read condition for elements contained in the personal information;
specifying means for, upon detecting that access information to access a patient's medical image in the database is input from an outside, specifying a readable element of the elements contained in the personal information registered in the database in association with the medical image;
read means for reading out the element specified by said specifying means and the medical image from the database; and
output means for outputting the element read out by said read means and the medical image to the outside.

2. The apparatus according to claim 1, wherein the elements contained in the personal information include a name of the patient, a name of a disease of the patient, a date of birth of the patient, an age of the patient, and a sex of the patient.

3. The apparatus according to claim 1, wherein
the access information includes identification information to identify an operator of a terminal operated to access the patient's medical image in the database, purpose information representing a purpose of the access, and image identification information to identify the medical image, and
said specifying means specifies, of the elements contained in the personal information, the readable element in accordance with a combination of the identification information, the purpose information, and the image identification information input from the outside by referring to the read condition.

4. The apparatus according to claim 2, wherein the read condition is determined on the basis of a name of a disease stored in the database.

5. An information processing method executed by an information processing apparatus capable of accessing a database in which a plurality of sets of a patient's medical image and personal information about the patient are registered, comprising:
a holding step of holding, in a memory, a read condition for elements contained in the personal information;
a specifying step of, upon detecting that access information to access a patient's medical image in the database is input from an outside, specifying a readable element of the elements contained in the personal information registered in the database in association with the medical image;
a read step of reading out the element specified in the specifying step and the medical image from the database; and
an output step of outputting the element read out in the read step and the medical image to the outside.

6. A program causing a computer to execute an information processing method of claim 5.

7. A computer-readable storage medium storing a program of claim 6.
